(19) United States
(12) Patent Application Publication
(10) Pub. No.: US 2004/0107106 A1
(43) Pub. Date: Jun. 3, 2004

(54) Apparatus and methods for generating visual representations of speech verbalized by any of a population of personas

(75) Inventors: Nachshon Margaliot, Elkana (IL); Gad Blilious, Jerusalem (IL)

Correspondence Address: DARBY & DARBY P.C., Post Office Box 5257, New York, NY, 10150-5257, US

(73) Assignee: SPEECHVIEW LTD., Petach Tikva (IL)

(21) Appl. No.: 10/606,921

(22) Filed: Jun. 19, 2003

Related U.S. Application Data
(63) Continuation of application No. PCT/IL01/01175, filed on Dec. 18, 2001.
(60) Provisional application No. 60/256,606, filed on Dec. 19, 2000.

(51) Int. Cl. G10L 21/00; G10L 11/00

(52) U.S. Cl. 704/270

(57) ABSTRACT

A system for enhancing an audio reception experience including a visual output device, visual content storage supplying visual content to the visual output device, an audio player operative to play audio content containing non-synthesized voice, and an audio-visual coordinator operative to cause the visual output device to display the visual content in a manner coordinated with the non-synthesized voice.

### FIELD OF THE INVENTION

The present invention relates to apparatus and methods for communicating speech between remote communicants.

### BACKGROUND OF THE INVETION

Copending Published PCT Application PCT/IU00/00809 (WO 01/50726A1 describes a phoneme-based system for providing a visible indication of speech.

Technologies relevant to voice production and visual representations thereof are described in the following U.S. Pat. Nos. 4,884,972, 5,278,943, 5,613,056, 5,630,017, 5,689,618, 5,734,794, and 5,923,337. U.S. Pat. No. 5,878,396 describes frame-based viseme production.

An article entitled “Videorealistic talking faces: A morphing approach” is posted on Internet at the following link:

//cuneus.ai.mit.edu:8000/publications/avsp97.pdf

Other relevant documents include:

M. M. Cohen and D. W. Massaro, (1993) Modeling coarticulation in synthetic visual speech. In N. M. Thalrnann and D. Thalmann (Eds.), Models and Techniques in Computer Animation, pages 139-156. Springer-Verlag, Tokyo.

B. LeGoff and C. Benoit, (1996) A Text-to-audiovisual Speech Synthesizer for French. In Proceedings of the International Conference of Spoken Language Processing (ICSLP '96), Philadelphia, USA.

J. Olive, A. Greenwood, and J. Coleman, (1993) Acoustics of American English Speech: A Dynamic Approach. Springer-Verlag, New York, USA.

The disclosures of all publications mentioned in the specification and of the publications cited therein are hereby incorporated by reference.

### SUMMARY OF THE INVENTION

The present invention seeks to provide apparatus and methods for generating visual representations of speech verbalized by any of a population of personas.

There is thus provided, in accordance with a preferred embodiment of the present invention, a system for enhancing an audio reception experience including a visual output device, visual content storage supplying visual content to the visual output device, an audio player operative to play audio content containing non-synthesized voice, and an audio-visual coordinator operative to cause the visual output device to display the visual content in a manner coordinated with the non-synthesized voice.

Also provided, in accordance with another preferred embodiment of the present invention, is a system for enhancing an audio reception experience including a three-dimensional animated visual output device, visual content storage supplying visual content to the visual output device, an audio player operative to play audio content containing voice, and an audio-visual coordinator operative to cause the visual output device to display the visual content in a manner coordinated with the voice.

Further in accordance with a preferred embodiment of the present invention, the audio-visual coordinator is operative to extract phonemes from the voice and to match the phonemes to visemes in the visual content.

Further provided, in accordance with another preferred embodiment of the present invention, is a system for enhancing an audio reception experience including a visual output device, visual content storage supplying visual content to the visual output device, an audio player operative to play audio content containing voice, and an audio-visual coordinator operative to cause the visual output device to display the visual content in a manner coordinated with the voice, the audio-visual coordinator being operative to extract phonemes from the voice and to match the phonemes to visemes in the visual content.

Further in accordance with a preferred embodiment of the present invention, the visual content includes at least one image of at least one person speaking.

Still further in accordance with a preferred embodiment of the present invention, the at least one image includes a plurality of images, each representing at least one viseme.

Further in accordance with a preferred embodiment of the present invention, the visual output device includes a display screen.

Still further in accordance with a preferred embodiment of the present invention, the visual output device includes a three-dimensional animated object.

Additionally in accordance with a preferred embodiment of the present invention, the three-dimensional animated object is operative to present a plurality of different visemes.

Further in accordance with a preferred embodiment of the present invention, the three-dimensional animated object is operative to present visemes which are time coordinated with phonemes in the voice.

Still further in accordance with a preferred embodiment of the present invention, the visual output device is operative to provide visual cues coordinated with various parameters of the voice.

Additionally in accordance with a preferred embodiment of the present invention, the various parameters include at least one of: intonation, volume, pitch, and emphasis.

Also provided, for use with a visual output device and an audio player operative to play audio content in accordance with a preferred embodiment of the present invention, is an audio reception experience enhancement module including visual content storage supplying visual content to the visual output device, and an audio-visual coordinator operative to cause the visual output device to display the visual content in a manner coordinated with the audio content.

Further provided, for use with a three-dimensional animated visual output device and an audio player operative to play audio content in accordance with a preferred embodiment of the present invention, is an audio reception experience enhancement module including visual content storage supplying visual content to the visual output device, and an audio-visual coordinator operative to cause the visual output device to display the visual content in a manner coordinated with the audio content.

Additionally provided, for use with a visual output device and an audio player operative to play audio content in accordance with a preferred embodiment of the present invention, is an audio reception experience enhancement module including visual content storage supplying visual content to the visual output device, and an audio-visual coordinator operative to cause the visual output device to display the visual content in a manner coordinated with the audio content, the audio-visual coordinator being operative to extract phonemes from the audio content and to match the phonemes to visemes in the visual content.

Also provided, in accordance with another preferred embodiment of the present invention, is apparatus for generating a visual representation of speech including a reservoir of viseme profiles storing at least one viseme profile, each viseme profile including a complete set of visemes respectively depicting different speech production positions of a persona, each viseme profile being linked to information identifying its persona, a phoneme extractor operative to receive a speech input and to derive therefrom a timed sequence of phonemes included therewithin, and a visual speech representation generator operative to access a viseme profile from the reservoir and to present a visual representation to accompany the speech input, the visual representation including a viseme sequence formed from visemes included in the viseme profile which respectively match the phonemes in the timed sequence, wherein the visual representation generator presents each viseme generally simultaneously with its matching phoneme.

Further in accordance with a preferred embodiment of the present invention, the apparatus also includes a user interface operative to prompt a user to define at least one characteristic of at least one telephone communication session and to select at least one viseme profile within the reservoir to be associated with the telephone communicant.

Still further in accordance with a preferred embodiment of the present invention, the visual speech representation generator is operative to present a visual representation formed from the viseme profile selected by the user, to accompany a speech input generated in the course of the telephone communication session.

Further in accordance with a preferred embodiment of the present invention, the visual speech representation generator includes apparatus for generating a visual speech representation which is integrally formed with a household appliance.

Still further in accordance with a preferred embodiment of the present invention, the reservoir of viseme profiles includes a user interface operative to prompt a user to provide a viseme profile access request including confirmable information identifying a persona whose viseme profile the user wishes to access, and also operative to provide the persona's viseme profile to the user.

Additionally in accordance with a preferred embodiment of the present invention, the user interface and the user communicate via a computer network such as the Internet.

Also provided, in accordance with another preferred embodiment of the present invention, is a business card including a card presenting contact information regarding a bearer of the card including information facilitating access to a viseme profile of the bearer.

Further provided, in accordance with still another preferred embodiment of the present invention, is stationery apparatus including stationery paper including a header presenting contact information for at least one individual including information facilitating access to a viseme profile of at least one individual.

Also provided, in accordance with yet another preferred embodiment of the present invention, is a website including a web page presenting contact information for at least one individual associated with the website including information facilitating access to a viseme profile of the individual.

Further in accordance with a preferred embodiment of the present invention, the visual speech representation generator includes apparatus for generating a visual speech representation which is integrally formed with a goods vending device.

Still further in accordance with a preferred embodiment of the present invention, the goods vending device includes a beverage dispensing machine.

Additionally in accordance with a preferred embodiment of the present invention, the visual speech representation generator includes apparatus for generating a visual speech representation which is integrally formed with a services dispensing device.

Still further in accordance with a preferred embodiment of the present invention, the services dispensing device includes an automatic bank teller.

Further in accordance with a preferred embodiment of the present invention, the visual speech representation generator is operative to present the visual representation on a display screen of a communication device.

Still further in accordance with a preferred embodiment of the present invention, the communication device includes an individual one of the following group of communication devices having display screens: personal digital assistant, cellular telephone such as a third generation cellular telephone, wired telephone, radio, interactive television, beeper device, computer such as a personal computer, portable computer or household computer, television, screenphone, electronic game, and devices having a plurality of physical positions which can be correspond to speech production positions.

Also provided, in accordance with a preferred embodiment of the present invention, is a method for generating a visual representation of speech including providing a reservoir of viseme profiles storing at least one viseme profile, each viseme profile including a complete set of visemes respectively depicting different speech production positions of a persona, each viseme profile being linked to information identifying its persona, receiving a speech input and deriving therefrom a timed sequence of phonemes included therewithin, and accessing a viseme profile from the reservoir and presenting a visual representation to accompany the speech input, the visual representation including a viseme sequence formed from visemes included in the viseme profile which respectively match the phonemes in the timed sequence, wherein each viseme is presented generally simultaneously with its matching phoneme, Further in accordance with a preferred embodiment of the present invention, the step of providing a reservoir includes, for each of a plurality of personas, generating a sequence of visual images representing the persona uttering a speech specimen including all visemes in a particular language, and identifying from within the sequence of visual images, and storing, a complete set of visemes.

Also provided, in accordance with another preferred embodiment of the present invention, is apparatus for generating a visual representation of speech including a toy having several speech production positions, a speech production position memory associating each phoneme in a language with an individual one of the speech production positions, a phoneme extractor operative to receive a speech input, to derive therefrom a timed sequence of phonemes included therewithin, and to derive therefrom, using the speech production position memory, a correspondingly timed sequence of speech production positions respectively corresponding to the phonemes in the timed sequence, and a toy speech position controller operative to actuate the toy to adopt the correspondingly timed sequence of speech production positions.

Further in accordance with a preferred embodiment of the present invention, the user interface is also operative to impose a charge for providing the persona's viseme profile to the user including obtaining the user's approval therefor before providing the persona's viseme profile to the user.

Further in accordance with a preferred embodiment of the present invention, the step of providing includes storing at least one viseme profile in a first communication device serving a first communicant and, upon initiation of a communication session between the first communicant and a second communicant, transmitting the viseme profile between the first communication device and a second communication device serving the second communicant, and wherein the step of accessing and presenting includes presenting, on a screen display associated with the second communication device, a viseme sequence formed from visemes included in the viseme profile transmitted from the first communicant to the second communicant.

Further in accordance with a preferred embodiment of the present invention, the step of transmitting includes sending the viseme profile in near real time via a data channel while a telephone call is in progress.

Still further in accordance with a preferred embodiment of the present invention, the step of sending employs a multimedia messaging service.

Additionally in accordance with a preferred embodiment of the present invention, the reservoir, phoneme extractor and visual speech representation generator are all cached in a telephone.

### BRIEF DESCRIPTION OF THE DRAWINGS

The present invention will be understood and appreciated from the following detailed description, taken in conjunction with the drawings in which:

FIG. 1A is a simplified semi-pictorial semi-functional block diagram illustration of a set-up stage of a system for constructing visual representations of speech as verbalized by a selected persona, the system being constructed and operative in accordance with a preferred embodiment of the present invention;

FIG. 1B is a simplified semi-pictorial semi-functional block diagram illustration of the system of FIG. 1A, after the set-up stage of FIG. 1A has been completed, facilitating a communication session between two communicants by constructing a visual representation of speech produced by a first of the two communicants, and displaying the visual representation to the second of the two communicants;

FIG. 2A is a duplex variation of the apparatus of FIG. 1A;

FIG. 2B is a simplified semi-pictorial semi-functional block diagram illustration of the system of FIG. 2A, after the set-up stage of FIG. 2A has been completed, facilitating a communication session between two communicants by constructing a visual representation of speech produced by the second of the two communicants, and displaying the visual representation to the first of the two communicants;

FIG. 3 is a simplified pictorial illustration of one embodiment of the present invention in which a videotape of a persona uttering an all-viseme containing speech specimen is generated at a retail outlet;

FIG. 4 is a simplified pictorial illustration of a persona generating a videotape of himself uttering an all-viseme containing speech specimen, using a digital camera such as a digital camera embedded within a third-generation cellular telephone;

FIG. 5A is a simplified pictorial illustration of a system for constructing visual representations of speech, including a server storing viseme profiles which downloads viseme profiles to a plurality of destinations each including a communication device with visual capabilities;

FIG. 5B is a simplified pictorial illustration of a user interface for the system of FIG. 5A, constructed and operative in accordance with a first preferred embodiment of the present invention;

FIGS. 6A-6C, taken together, form a simplified pictorial illustration of a user interface for the system of FIG. 5A, constructed and operative in accordance with a second preferred embodiment of the present invention;

FIG. 6D is a simplified pictorial illustration of the system of FIG. 5A having the user interface of FIGS. 6A-6C, facilitating a communication session between two users;

FIGS. 7A-7B, taken together, form a simplified pictorial illustration of a residence including various household appliances which are operative to provide spoken messages, in conjunction with a system for constructing visual representations of speech as verbalized by a selected persona, constructed and operative in accordance with a preferred embodiment of the present invention;

FIG. 8 is a simplified pictorial illustration of a network of vending or dispensing devices, each interacting via a computer network with a system for constructing visual representations of speech as verbalized by a selected persona, constructed and operative in accordance with a preferred embodiment of the present invention;

FIGS. 9A-9C, taken together, form a simplified pictorial illustration of a toy whose face has several speech production positions, visually representing, for a child playing with the toy, at least one viseme within a speech message which the toy has received from a remote source such as the child's parent;

FIG. 10 is a simplified flowchart illustration of a first, set-up stage in a preferred method for phoneme-level generation of a visual representation of a speech input, operative in accordance with a preferred embodiment of the present invention; and

FIG. 11 is a simplified flowchart illustration of a second, real-time stage in a preferred method for phoneme-level generation of a visual representation of a speech input, operative in accordance with a preferred embodiment of the present invention.

### DETAILED DESCRIPTION OF PREFERRED EMBODIMENTS

A viseme is a visual representation of a persona uttering a particular phoneme. Typically, a language has less visemes than phonemes, since phonemes which have the same visual appearance when produced, such as “b”, “m” and “p” or such as “f” and “v”, “collapse” into a single ambiguous viseme. Typically, a single-frame “still” representation of a face uttering a phoneme is sufficient to serve as a viseme.

A persona is any entity capable of visually representing speech production, such as a real or imaginary person, animal, creature, humanoid or other object.

Methods for identifying a set of visemes which when combined can visually represent substantially any speech specimen in a given language, are known. For example, one set of phonemes for describing the American English language has been described in “American English”, by Peter ladefoged, published in Handbook of the IPA (International Phonetic Association) 1999, pages 41-44, Cambridge University Press, The Edinburgh Building, Cambridge CB2 2RU, UK. Ladefoged's phoneme set includes the following phonemes which are grouped into 14 categories (15 categories including the blank (silence) phoneme):

1. p as in pie, b as in buy, m as in my

2. f as in fie, v as in vie,

3. t as in tie, d as in die, n as in nigh,

4. th as in thigh, th as in thy

5. s as in sigh, z as in zoo,

6. r as in rye, ir as in bird

7. l as in lie

8. k as in kite, g as in guy, h as in hang, h as in high

9. ch as in chin, g as in gin, sh as in shy, z as in azure,

10. long e as in bead, short i as in bid

11. short e as in bed, short a as in bad or as in above

12. short o as in pod or as in boy, long o as in bode

13. oo as in good, oo as in booed, w as in why

14. u as in bud or as in buy

15. (silence)

Each of the above 15 categories corresponds to a viseme, a positioning of the face which is employed by a speech model when uttering the particular phonemes included in that category. It is appreciated that the exact number of visemes and identity of each viseme is a matter of definition and need not be as defined above.

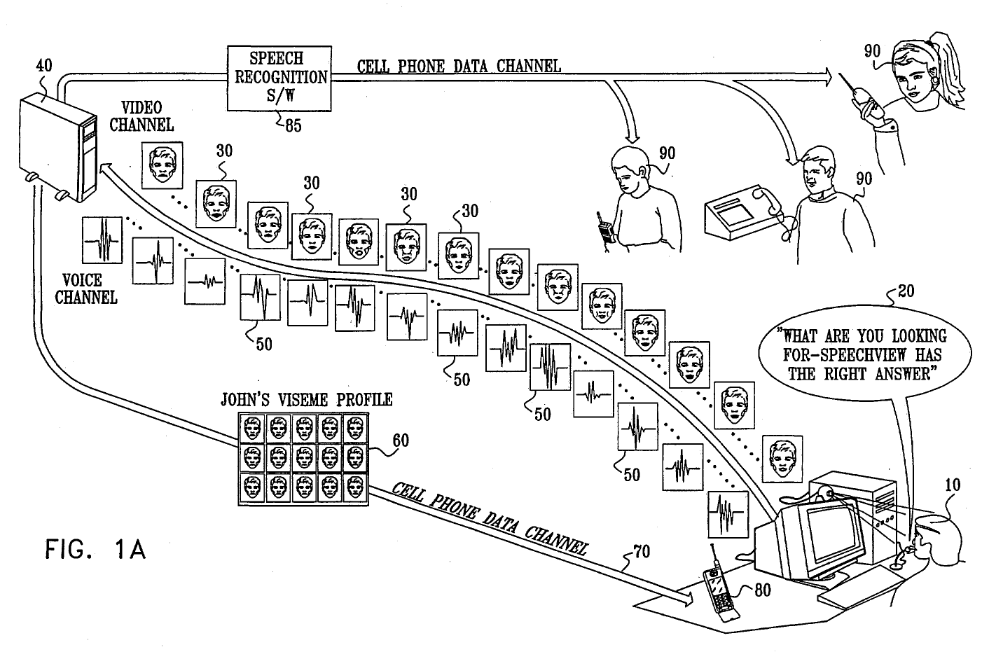

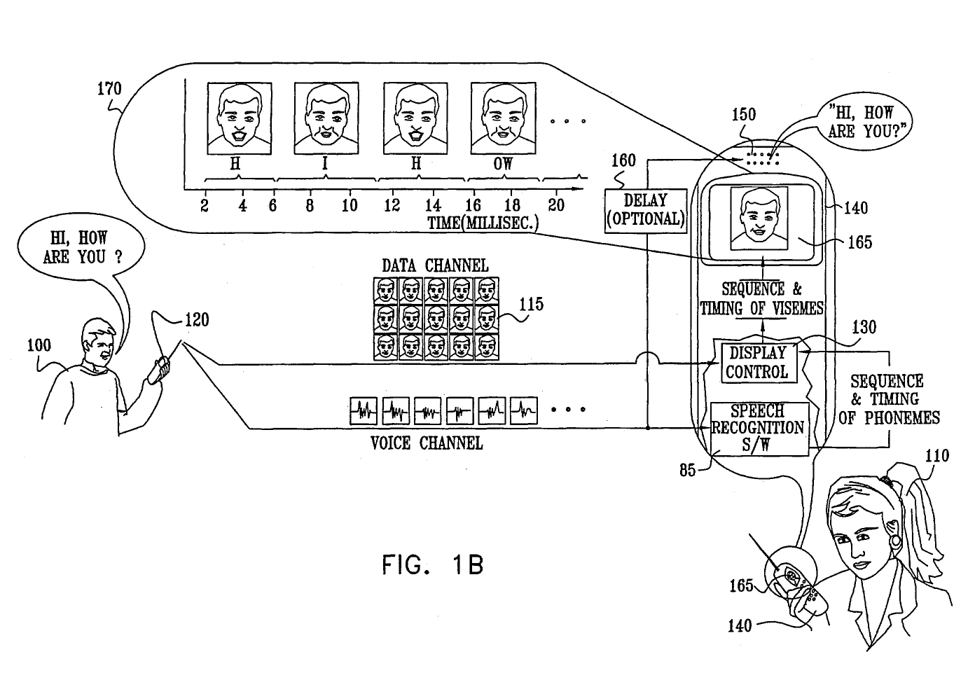

FIGS. 1A-9C are simplified pictorial illustrations of various embodiments of a system for accepting a speech input and generating a visual representation of a selected persona producing that speech input, based on a viseme profile previously generated for the selected persona. As shown, the system typically includes a multi-persona viseme reservoir storing, for each of a population of personas, a viseme profile including for each viseme, a visual image or short sequence of visual images representing the persona executing that viseme (e.g. verbalizing a phoneme corresponding to that viseme). The various variations illustrated in FIGS. 1A-9C are described in detail below, however it is appreciated that these variations are merely exemplary and do not represent the entire scope of the invention.

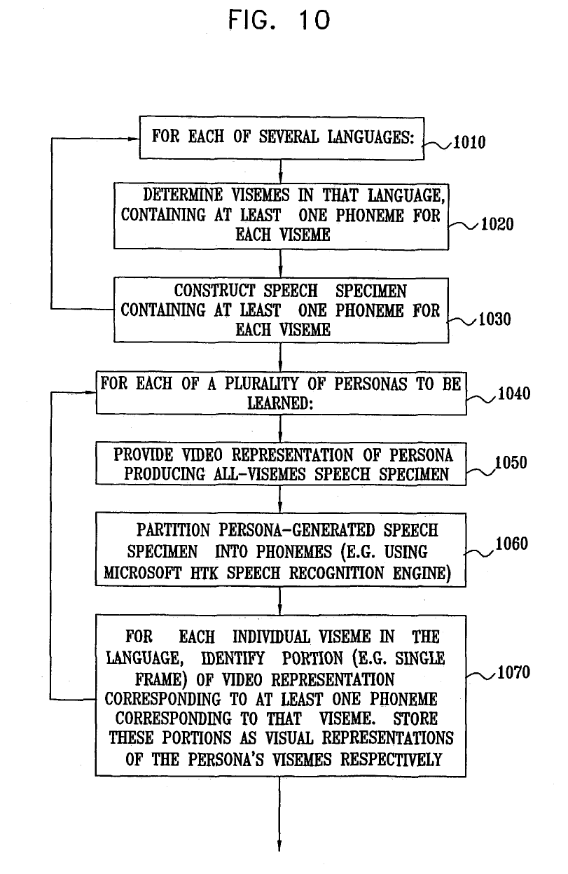

Reference is now made to FIG. 10 which is a simplified generally self-explanatory flowchart illustration of a first, set-up stage in a preferred method for phoneme-level generation of a visual representation of a speech input, operative in accordance with a preferred embodiment of the present invention.

In step 1020, a viseme set is defined to represent the language in question. An example of a viseme set for American English is described above. In step 1030, a sentence or other short speech segment is constructed which includes all visemes.

A simple sentence which includes each of the above described American English visemes at least once is: “What are you looking for—SpeechView has the right answer”. The sequence of visemes in this sentence is: 15, 13, 14, 3, 15, 14, 6, 15, 10, 13, 15, 7, 13, 8, 10, 3, 8, 15, 2, 12, 6, 15, 5, 1, 10, 9, 2, 10, 13, 15, 8, 11, 5, 15, 4, 10, 15, 6, 14, 10, 3, 15, 11, 3, 5, 6, 15. Preferably, a longer sentence is used, which includes each viseme several times. The speech recognizer then partitions a video sequence of a speech model uttering the longer sentence, into subsequences respectively corresponding to the known visemes. From among the temporal portions representing a particular viseme, such as viseme 3, the video subsequence chosen to represent that viseme is preferably that which corresponds to the “best uttered” phoneme i.e. the phoneme recognized by the speech recognizer with the highest degree of certainty.

In step 1050, a visual recording of a persona uttering the sentence or segment including all visemes, is generated.

Step 1050 may be implemented using any suitable procedure, depending on the application, such as but not limited to the following procedures:

a. A subject wishing to create a viseme profile for himself seeks instructions to do so e.g. by contacting a website of a commercial entity which provides viseme profile generation and downloading services. The site provides the subject with an all-visemes speech specimen, i.e. a short passage of speech, typically a sentence 2-3 seconds long which includes all possible visemes. The subject is instructed to use a computer camera to create an MPEG file of himself uttering the all-visemes speech specimen, and to forward the MPEG file for analysis, e.g. to the viseme profile generation and downloading website, e.g. as a video file through the Internet or another computer network.

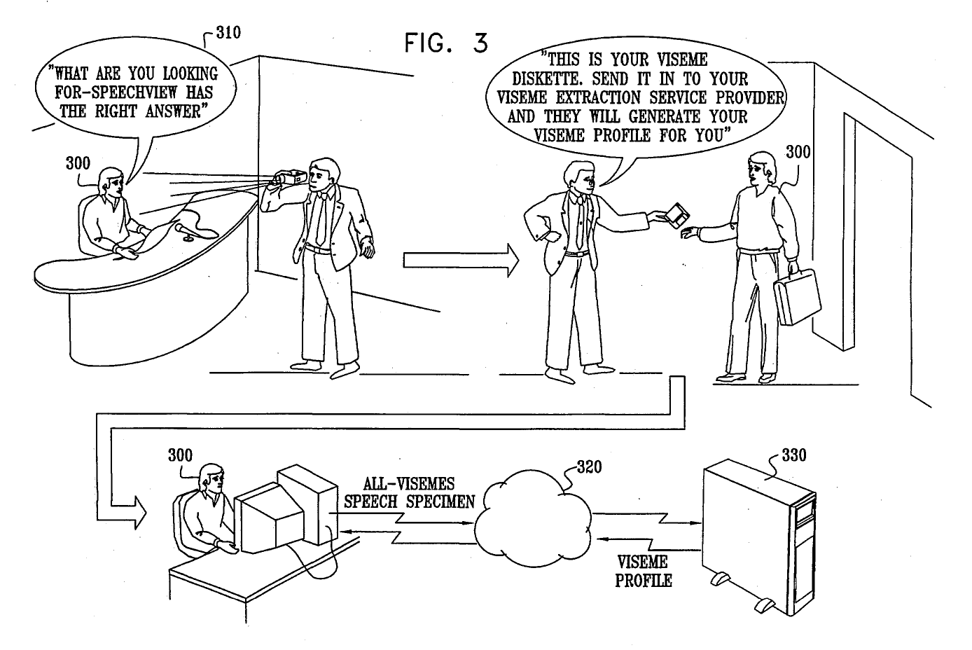

b. As shown in FIG. 3, a cooperating photography shop may prepare a video film of a subject producing an all-visemes speech specimen. The subject may then send the video film to a viseme profile generating service e.g. by personally delivering a diskette on which the video film resides, to the premises of such a service.

c. A professional studio may prepare a video film of a celebrity and may send the video film to a viseme profile generating service.

Partitioning of the speech specimen into phonemes (step 1060) may be performed by a conventional speech recognition engine such as the HTK engine distributed by Microsoft which recognizes phonemes and provides an output listing each phoneme encountered in the specimen, the time interval in which it appears and preferably, the level of confidence or probability that the phoneme has been correctly identified. The process of partitioning into phonemes may make use of information regarding expected phonemes because, since the speech specimen is known, generally it is known which phonemes are expected to occur and in what order.

According to a preferred embodiment of the present invention, the speech recognition engine employed in step 1060 differentiates between three different parts or “states” of each phoneme. The first state is the “entrance” to the phoneme and is linked to the preceding phoneme, the third state is the “exit” of the phoneme and is linked to the next phoneme. The second state “purely” represents the current phoneme and is therefore the video portion corresponding to the second state is typically the best visual representation of the current phoneme. The middle frame in the second-state video portion can be employed to represent the corresponding viseme. Alternatively, one or more frames in the first state of an n'th phoneme and/or one or more frames in the third states of an (n−1)th phoneme, can be employed to represent the transition between the (n−1)th to n'th phonemes.

An example of a speech recognizer which is suitable for performing the speech specimen partitioning step 1060 is Microsoft's HTK speech recognition engine, however, alternatively, any other suitable speech recognition engine may be employed.

The output of step 1070 is a “viseme profile” including, for each viseme, a visual representation, typically a single visual image, of the persona uttering that viseme. Alternatively, the viseme profile may be replaced by a dipthong-level profile including, for each dipthong in the language, a visual image of the persona uttering that dipthong.

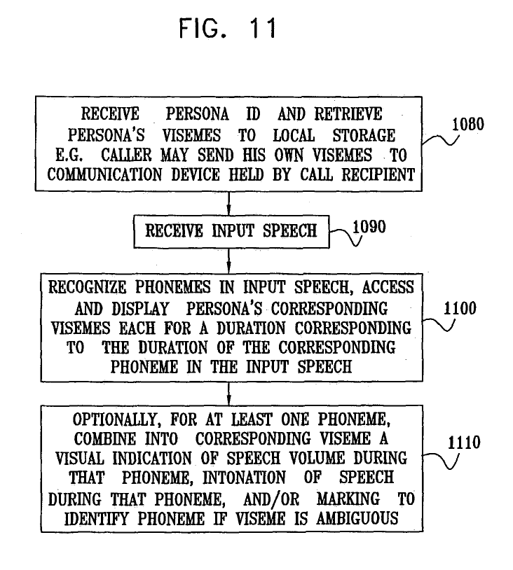

Reference is now made to FIG. 11 which is a simplified generally self-explanatory flowchart illustration of a second, real-time stage in a preferred method for phoneme-level generation of a visual representation of a speech input, operative in accordance with a preferred embodiment of the present invention. Typically, real-time refers to implementations in which less than 0.5 sec, typically approximately 300 msec, elapses from when a phoneme is uttered until the visual representation of that phoneme is displayed to the user.

In step 1080, any suitable means can be employed to select a suitable viseme profile. The person whose speech is being represented may select the viseme profile, or the person who is hearing the speech and watching the corresponding visemes may select the viseme profile, or a third party may select the viseme profile. Selection of a viseme profile may be carried out in advance, as part of a set up process, in which case typically, a viseme profile is selected for a group of communication sessions such as any communication session with a particular communicant, or any communication session taking place on Mondays. Alternatively, selection of a viseme profile may be carried out for each communication session, as an initial part of that communication session.

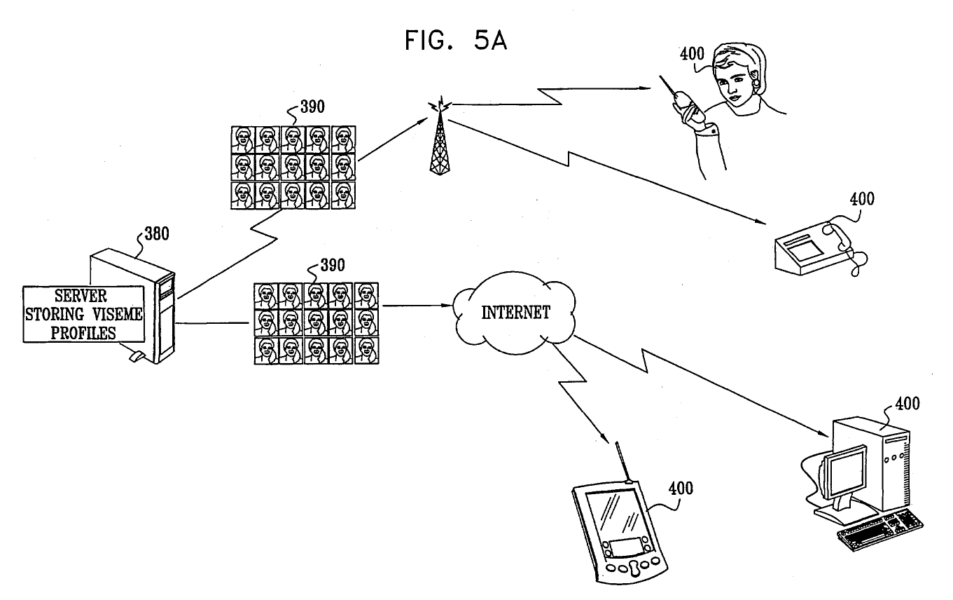

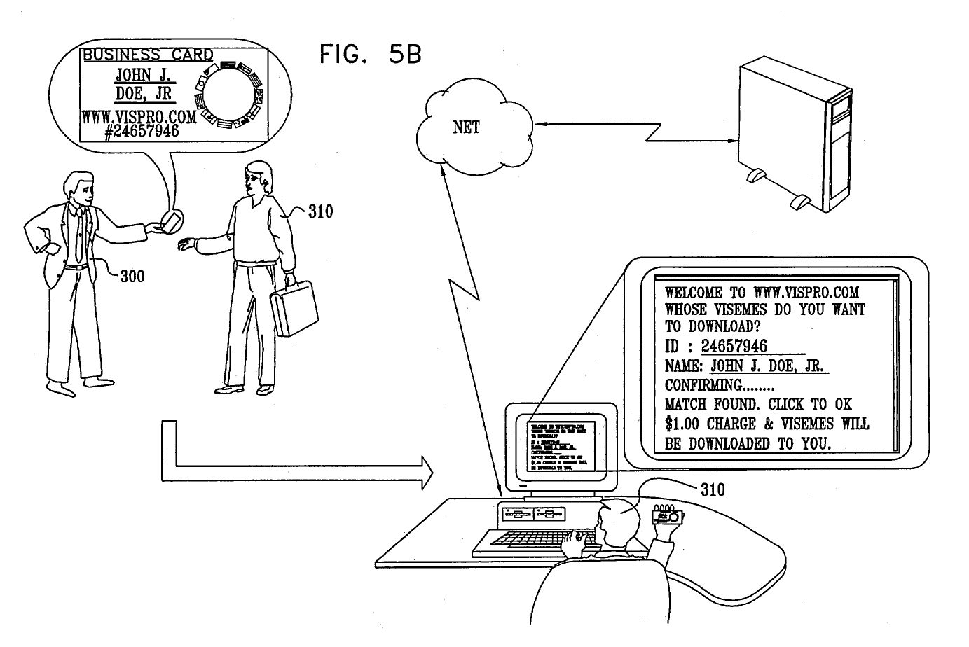

Once a viseme profile has been selected, it can be forwarded from the reservoir where it is stored to the communicant who is to view it, in any suitable manner. For example, as shown in FIG. 5A, a reservoir of viseme profiles may send a particular viseme profile by email to a communicant, or the communicant may download a desired viseme profile from a viseme reservoir computer network site storing a reservoir of viseme profiles. Also, viseme profiles may be downloaded from one communication device to another, via the data channel interconnecting the communication devices.

An input speech is received, typically from a first communicant who is communicating with a partner or second communicant (step 1090). The phoneme sequence and timing in the input speech are derived by a conventional speech recognition engine (step 1100) and corresponding visemes are displayed to the second communicant, each for an appropriate duration corresponding to the timing of the phonemes in the input speech, such that the viseme flow corresponds temporally to the oral flow of speech.

For at least one phoneme, additional elements can optionally be combined into the phoneme's corresponding viseme (step 1110), such as but not limited to a visual indication of speech volume during that phoneme, intonation of speech during that phoneme, and/or marking to identify phoneme if viseme is ambiguous. In step 1110, the system may, for example, mark the throat in “B” and mark the nose in “M” to show the difference between “B”, “P” and “M” which cannot be visually distinguished since they all reside within the same viseme.

FIGS. 1A-9C are now described in detail.

FIG. 1A is a simplified semi-pictorial semi-functional block diagram illustration of a set-up stage of a system for constructing visual representations of speech as verbalized by a selected persona, the system being constructed and operative in accordance with a preferred embodiment of the present invention. As shown, a persona 10 utters a speech specimen 20 including all visemes in a particular language such as American English. A sequence of visual images 30 of the persona 10 is transmitted e.g. over a video channel to a server 40 and a parallel sequence of sound waveforms 50 representing the sounds generated by the persona 10 is transmitted e.g. over a voice channel to the server 40. The server 40 is operative to derive a viseme profile 60 from the sequence 30 based on analysis of the sound waveform sequence as described in detail below with reference to FIG. 10. The viseme profile 60 is transmitted to a suitable destination and in the illustrated embodiment is shown transmitted over a cell phone data channel 70 to the persona's own communication device 80 although this need not be the case as described in detail below with reference to FIG. 5A. Also in the course of set-up, individuals who wish to have a visual representation of remotely located persons 90 speaking to them download or otherwise equip themselves with speech recognition software 85, preferably on a one-time basis. The speech recognition software is typically operative to perform phoneme recognition step 1100 in FIG. 11, described below in detail.

FIG. 1B is a simplified semi-pictorial semi-functional block diagram illustration of the system of FIG. 1A, after the set-up stage of FIG. 1A has been completed, facilitating a communication session between two communicants by constructing a visual representation of speech produced by a first of the two communicants (communicant 100) and displaying the visual representation to the second of the two communicants (communicant 110). As shown, as communicant 100 begins to speak, his viseme profile 115 which may be stored in memory in his own communication device 120, is transmitted over a suitable data channel to a memory location associated with a display control unit 130 in the communication device 140 serving communicant 110. Speech recognition software 85 receives the voice information over a suitable voice channel and the same voice information is conveyed directly to the earpiece 150 of the communication device 140, typically with slight delay 160 to give the speech recognition software 85 time to analyze incoming speech and generate, with only small delay, a viseme sequence to represent the incoming speech. The speech recognition software 85 derives a sequence of phonemes from the incoming speech and also preferably the timing of the phonemes. This information is fed to the display control unit 130 which generates a viseme sequence which temporally and visually matches the phonemes heard by the user in the sense that as the user hears a particular phoneme, he substantially simultaneously sees, on the display screen 165 of the communication device 140, a viseme, selected from the viseme profile 115 of communicant 100, which corresponds to that phoneme. The temporal matching between phonemes and visemes is illustrated pictorially in the graph 170.

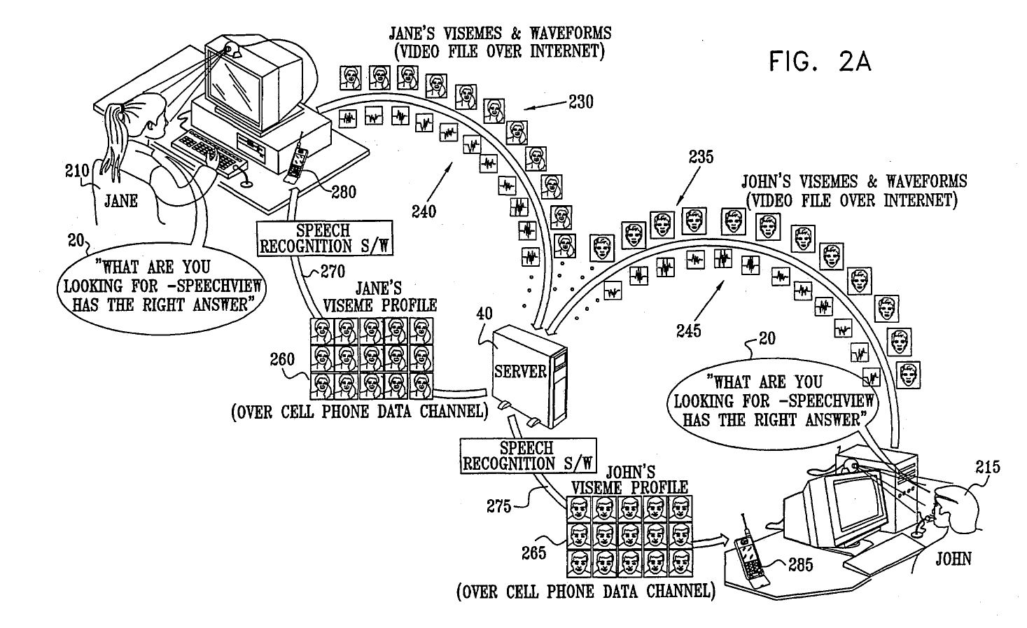

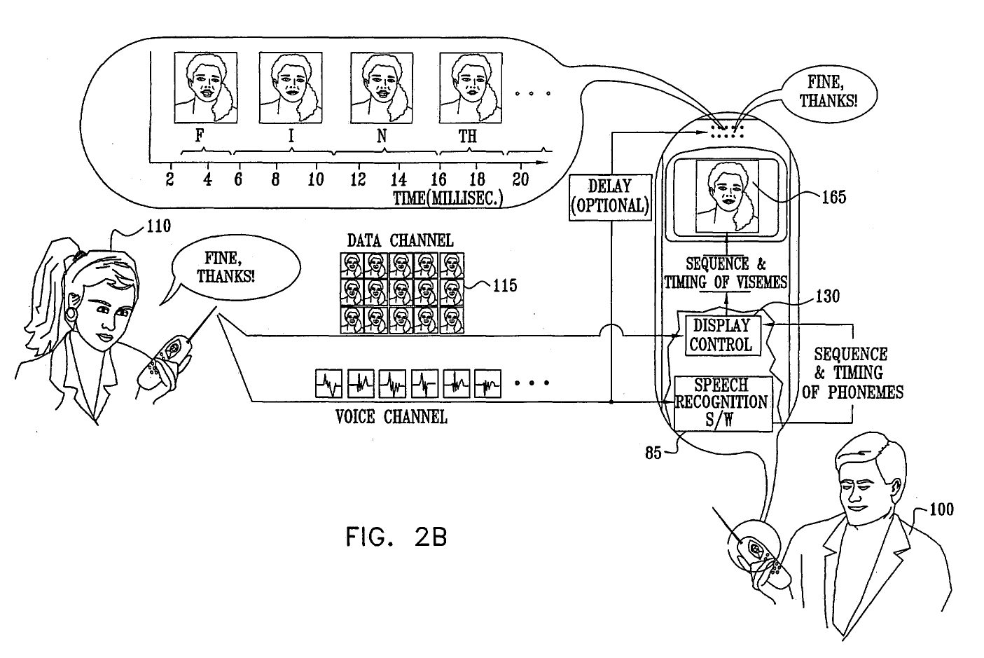

FIG. 2A is a duplex variation of the apparatus of FIG. 1A. As shown, a pair of persons 210 and 215 each utter a speech specimen 20 including all visemes in a particular language such as American English. Sequences of visual images 230 and 235 of the personas 210 and 215 respectively are transmitted e.g. as respective video files over Internet to a server 40 and respective parallel sequences of sound waveforms 240 and 245 representing the sounds generated by the personas 210 and 215 respectively are transmitted e.g. over voice channels to the server 40.

It is appreciated that the visual image sequences 230 and 235 can, if desired, be transmitted in real time e.g. over a video channel.

The server 40 is operative to derive viseme profiles 260 and 265 from the sequences 230 and 235 respectively based on analysis of the sound waveform sequences 240 and 245 respectively as described in detail below with reference to FIG. 10. The viseme profiles 260 and 265 are each transmitted to a suitable destination and in the illustrated embodiment are shown transmitted over respective cell phone data channels 270 and 275 to the respective persona's own communication devices 280 and 285 respectively although this need not be the case as described in detail below with reference to FIG. 5A.

Also in the course of set-up, each individual, including personas 210 and 215 who wish to have a visual representation of remotely located persons speaking to them download or otherwise equip themselves with speech recognition software 85, preferably on a one-time basis. The speech recognition software is typically operative to perform phoneme recognition step 1100 in FIG. 11, described below in detail.

FIG. 2B is a simplified semi-pictorial semi-functional block diagram illustration of the system of FIG. 2A, after the set-up stage of FIG. 2A has been completed, facilitating a communication session between two communicants by constructing a visual representation of speech produced by the second of the two communicants, and displaying the visual representation to the first of the two communicants. In FIG. 2B, the roles of the two communicants 100 and 110 in FIG. 1B are reserved as shown resulting in a display of visemes representing the speech of communicant 110, which appears on the display screen 165 of the communication device of communicant 100.

FIG. 3 is a simplified pictorial illustration of one embodiment of the present invention in which a videotape of a persona 300 uttering an all-viseme containing speech specimen is generated at a retail outlet. As shown, the persona is filmed, receives a video diskette storing a video representation of himself uttering the all-viseme speech specimen 310, and sends the video information in to a viseme extraction service provider, e.g. by transmitting the video information via a computer network 320 such as the Internet to the server 330 of the viseme extraction service provider or by delivering the diskette by hand to a viseme extraction service provider. The viseme extraction service provider generates a video profile for the persona 300 as described in detail below with reference to FIG. 10.

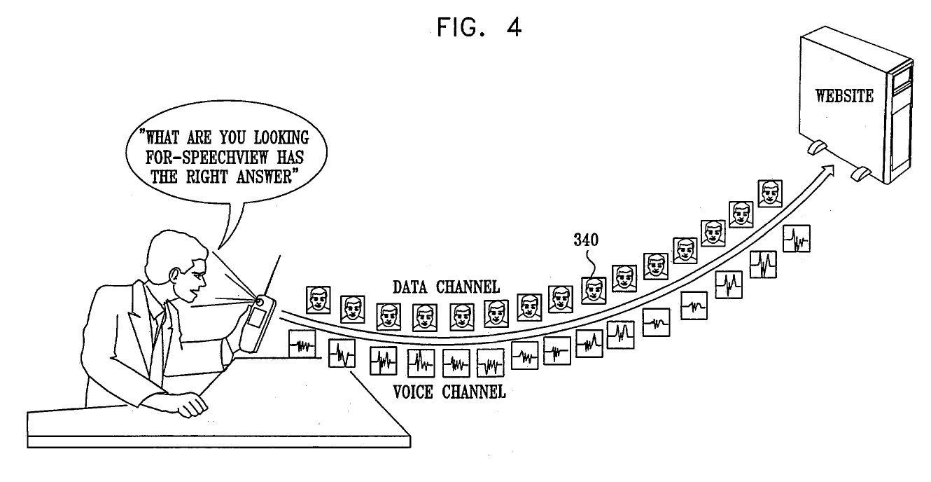

FIG. 4 is a simplified pictorial illustration of a persona generating a videotape of himself uttering an all-viseme containing speech specimen, using a digital camera such as a webcam or such as a digital camera embedded within a third-generation cellular telephone. Any camera installed on a computer such as a personal or laptop computer, capable of generating still or video images which can be transferred by the computer directly over the web, can serve as a webcam, such as the Xirlink IBM PC Camera Pro Max, commercially available from International Business Machines, or such as the Kodak DVC 325 digital camera or such as a digital camera embedded within a third generation cellular telephone.

FIG. 5A is a simplified pictorial illustration of a system for constructing visual representations of speech, including a server 380 storing viseme profiles 390 which downloads viseme profiles to a plurality of destinations 400 each including a communication device with a display screen or other suitable visual capabilities such as a mobile telephone, palm pilot, IP-telephone or other communication device communicating via a computer network. Transmission of viseme profiles to the destination may be via a computer network or a wired or cellular telephone network or by any other suitable communication medium. An example of a suitable IP-telephone is the i.Picasso™6000 IP Telephone commercially available from Congruency, Inc. of Rochelle Park, N.J. and Petah-Tikva, Israel.

FIG. 5B is a simplified pictorial illustration of a user interface for the system of FIG. 5A, constructed and operative in accordance with a first preferred embodiment of the present invention. As shown, once a persona 300 has generated a viseme profile for himself and stored it in a viseme profile reservoir managed typically by a commercial entity, the persona 300 can invite an acquaintance 310 to download his viseme profile. For example, if the viseme profile reservoir is accessed by providing particulars such as persona's ID and name, the persona 300 may post these particulars on his business card, website or stationary, also posting the particulars of the commercial entity which manages the viseme profile reservoir in which his viseme profile is stored. In the illustrated embodiment, the commercial entity resides at a website entitled www.vispro.com. The acquaintance 310 may then obtain, e.g. download, from the viseme profile reservoir, the viseme profile of persona 300 who he has just met, as shown.

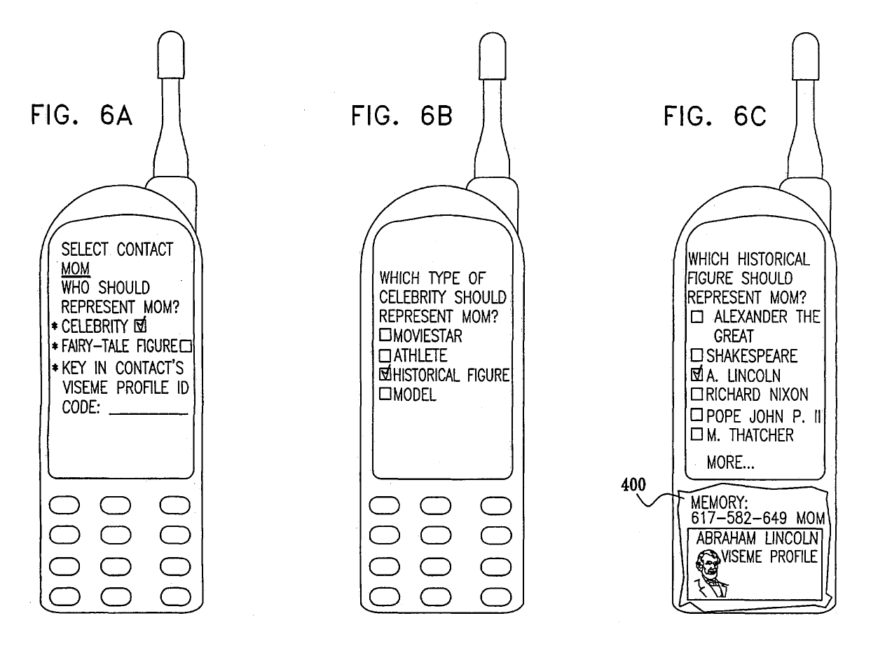

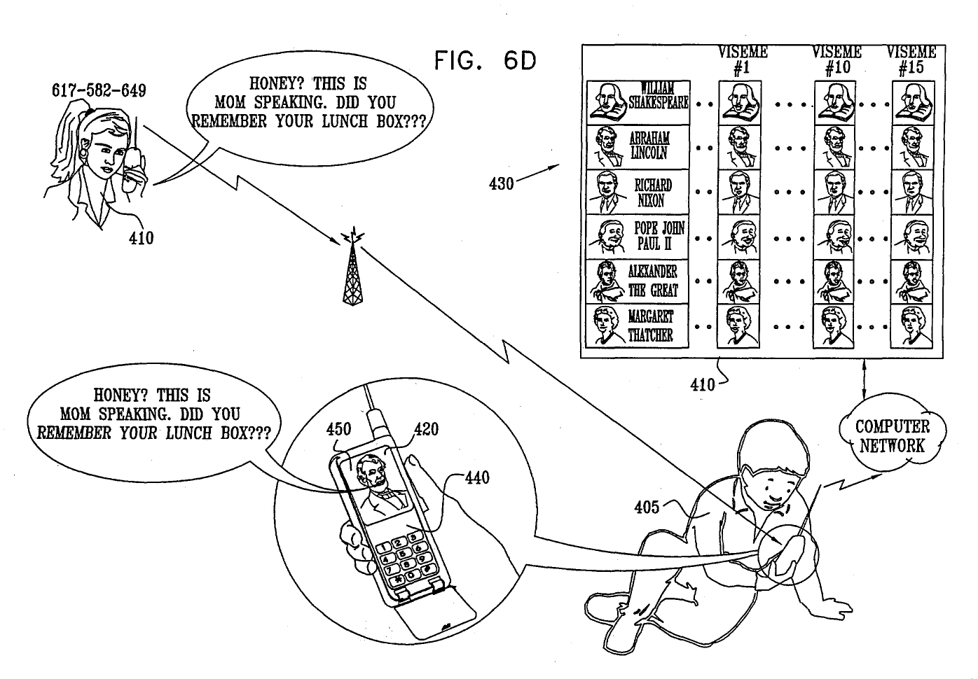

FIGS. 6A-6C, taken together, form a simplified pictorial illustration of a user interface for the system of FIG. 5A, constructed and operative in accordance with a second preferred embodiment of the present invention. FIG. 6D is a simplified pictorial illustration of the system of FIG. 5A having the user interface of FIGS. 6A-6C, facilitating a communication session between two users.

As shown, the user interface of FIGS. 6A-6D invites a telephone subscriber to associate a persona with each of a plurality of telephone contacts such as the telephone contacts stored in the memory of his telephone. In FIG. 6A, the telephone subscriber 405 (FIG. 6D) selects a contact (Mom, whose telephone number is 617 582 649) with which he desires to associate a new persona, and the user interface prompts the subscriber to define the type of persona with which the contact should be associated, using categories such as celebrity, fanciful figure, or ordinary individuals (acquaintances of the subscriber) in which case the individual's viseme profile ID is elicited from the subscriber. In FIG. 6B, the category of persona is further narrowed. In FIG. 6C, a specific persona (Lincoln) within the selected category (historical figure) is selected by the subscriber resulting in storage, in memory 400, of the viseme profile of Lincoln in association with the particulars of the contact. The memory 400 also includes other viseme profiles associated respectively with other contacts.

The viseme profile selected by the subscriber is typically downloaded from a central viseme profile reservoir 410 (FIG. 6D). When a telephone contact 410 to whom a viseme profile has been assigned, contacts the subscriber 405, as shown in FIG. 6D, the appropriate viseme profile is accessed, e.g. based on identification of the telephone number and/or “speech signature” of the telephone contact, and the speech of the telephone contact 410, Mom, is represented using appropriate Abraham Lincoln visemes 420 within the Lincoln viseme profile 430 assigned by subscriber 404 to “Mom”.

More generally, in FIGS. 6A-6D, a “virtual-video” communication device 440 e.g. telephone is provided which is equipped with a screen 450 and has in an associated memory a plurality of viseme profiles 430 which may, as shown, be downloaded via a computer network 440 from the acquaintance viseme reservoir 410. The reservoir 410 stores a plurality of viseme profiles 430, each including a plurality of visemes representing a corresponding plurality of personae. The personae may be celebrities, imaginary figures or acquaintances of the telephone subscriber. Once a viseme profile 430 is downloaded to a subscriber's communication device, it is typically linked to the telephone number or caller ID or speech signature of at least one individual acquaintance of the subscriber.

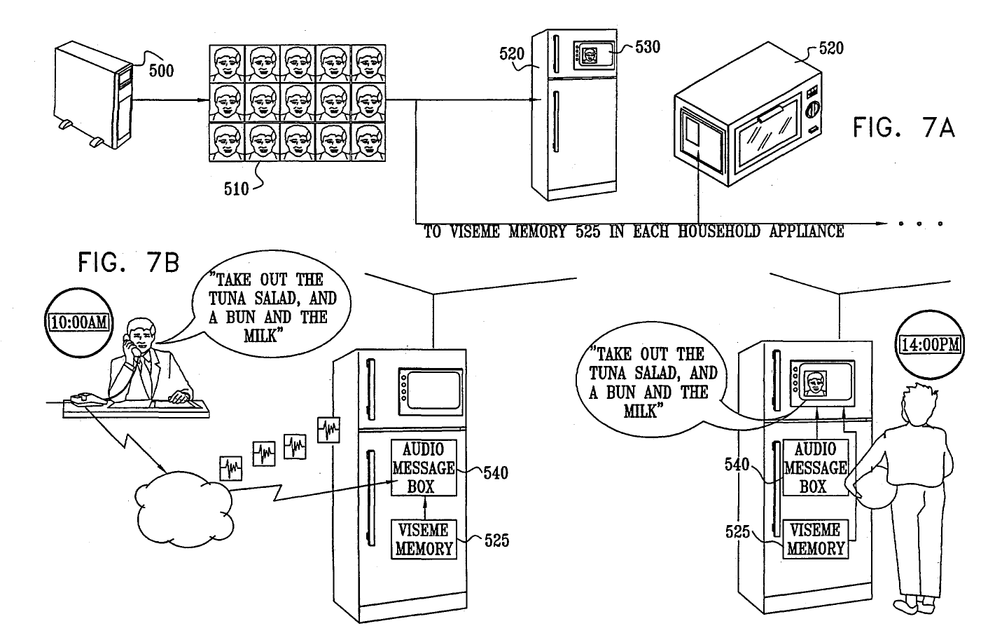

FIGS. 7A-7B, taken together, form a simplified pictorial illustration of a residence including various household appliances which are operative to provide spoken messages, in conjunction with a system for constructing visual representations of speech as verbalized by a selected persona, constructed and operative in accordance with a preferred embodiment of the present invention.

According to a preferred embodiment each household appliance is associated with a persona which may be fixed or user-selected. Each spoken message uttered by an appliance is delivered with voice characteristics corresponding to the persona and is accompanied by a visual representation, e.g. on a screen integrally formed with the appliance, of the persona uttering the spoken message.

It is appreciated that the platforms at which at least one viseme of at least one persona are represented need not be household appliance platforms and alternatively may comprise any suitable platform or automated machine or screen-supported device or oral/visual information presentation device such as but not limited to commercial dispensers such as beverage machines, PDA (personal digital assistant), cellular telephones, other highly portable oral information presentation devices such as wrist-wearable oral information presentation devices, wired telephone, VoIP (voice over Internet) applications, board computers, express check-in counters e.g. for air-travel, ticket outlet machines e.g. for train or airplane trips.

Other applications for which the present invention is useful include visually presented fan mail, personalized birthday cards including an oral message, visual email, and visual SMS.

Referring specifically to the example illustrated in FIGS. 7A-7B, a server 500 associated with a viseme profile reservoir (not shown) sends a viseme profile 510 which may be user-selected or system-selected, to each of a plurality of participating household appliances 520 each having at least one communication capability such as a message box capability and each having a display screen 530. As shown in FIG. 7B, a caller such as a child's parent may leave a message in the audio message box 540 of a household appliance. At a later time, such as when the child reaches home, the child retrieves the message. The message is presented not only orally, but also visually, by presenting visemes which match the speechflow, as described in detail herein, from the viseme profile 510 stored in a viseme memory 525 associated with the household appliance.

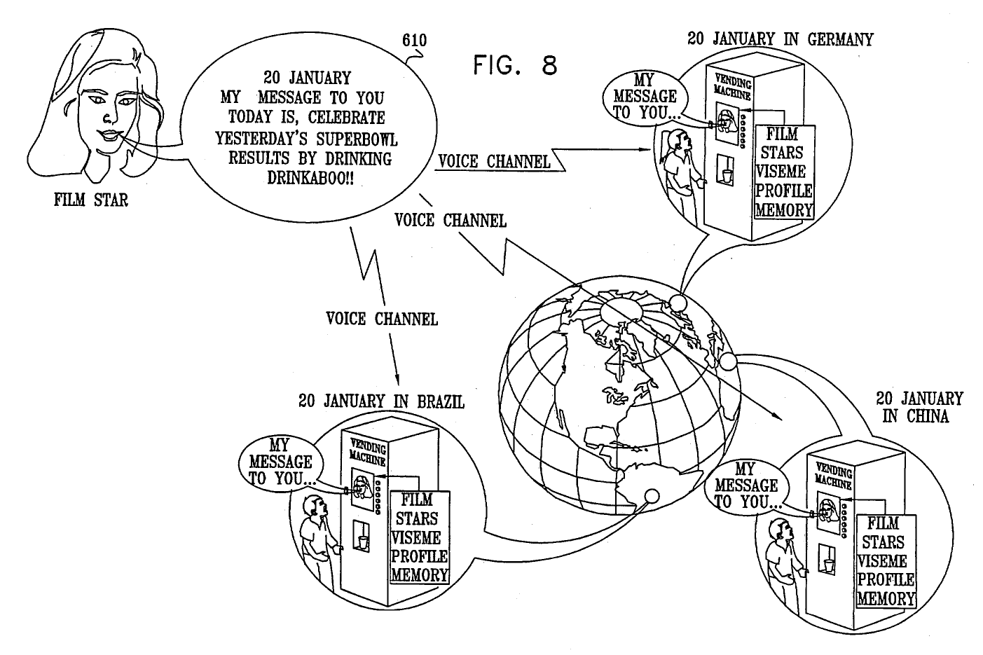

FIG. 8 is a simplified pictorial illustration of a network of vending or dispensing devices 600 each interacting via a computer network with a system for constructing visual representations of speech as verbalized by a selected persona, constructed and operative in accordance with a preferred embodiment of the present invention. As shown, the embodiment of FIG. 8 allows a visual representation of a celebrity's “message of the day” 610 to be provided at any of a large plurality of dispensing or vending locations 600, without requiring cumbersome transmittal of an actual visual recording of the celebrity's uttering the “message of the day”. This is done by performing the speech recognition functionalities shown and described herein, either locally or at a single central location, in order to derive the identity and temporal location of each phoneme within the “message of the day”. Once the display control unit at each vending or dispensing machine has received from a local or centrally located phoneme recognizer, the identity and temporal location of the phonemes in the message of the day, the display control unit then generates a viseme sequence which temporally matches the flow of phonemes within the message of the day.

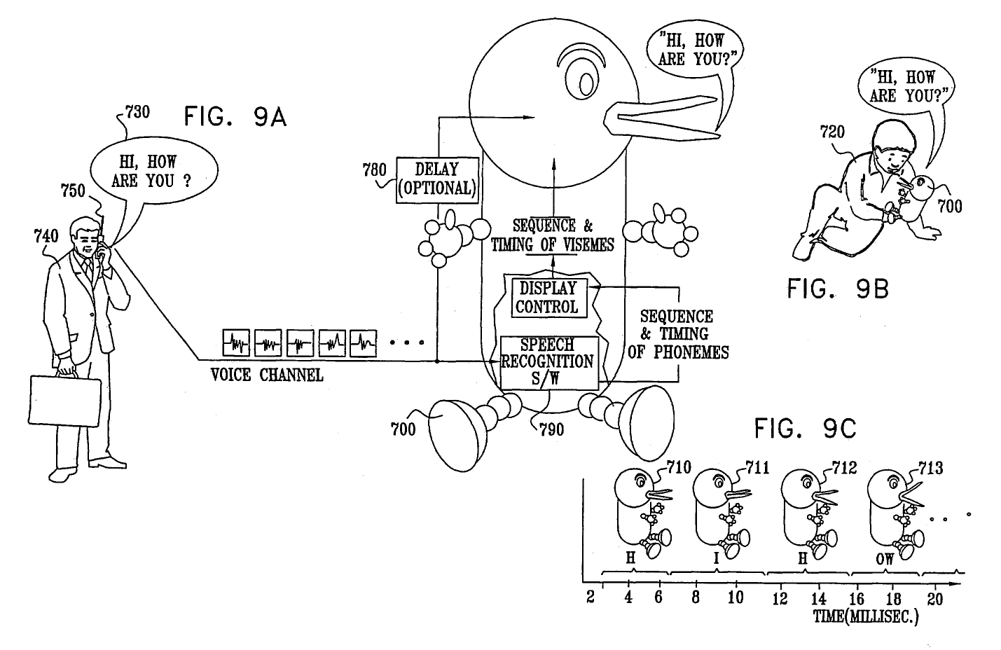

FIGS. 9A-9C, taken together, form a simplified pictorial illustration of a toy 700 whose face has several computer-controllable speech production positions 710-713, visually representing, for the benefit of a child 720 playing with the toy, at least one viseme within a speech message 730 which the toy has received from a remote source 740 such as the child's parent via a pair of communication devices including the communication device 750 at the remote location and the toy 700 itself which typically has wireless e.g. cellular communication capabilities. The operation of the embodiment of FIGS. 9A-9C is similar to the operation of the embodiment of FIG. 1B except that visemes are not represented by typically 2D images of a physical figure and instead are represented by a toy figure having a plurality of computer-controllable speech production positions. Therefore, it is not necessary for the remote source 740 to transmit his viseme profile to the toy 700. Each speech production position is a unique combination of positions of one or more facial features such as the mouth, chin, teeth, tongue, nose, eyebrows and eyes.

FIG. 10 is a simplified flowchart illustration of a first, set-up stage in a preferred method for phoneme-level generation of a visual representation of a speech input, operative in accordance with a preferred embodiment of the present invention.

FIG. 11 is a simplified flowchart illustration of a second, real-time stage in a preferred method for phoneme-level generation of a visual representation of a speech input, operative in accordance with a preferred embodiment of the present invention.

According to one alternative embodiment of the present invention, each viseme profile is stored in association with a voice sample or “voice signature”. Voice recognition software is used to recognize an incoming voice from among a finite number of voices stored in association with corresponding viseme profiles by a communication device. Once the incoming voice is recognized, the viseme profile corresponding thereto can be accessed. The voice recognition process is preferably a real time process. The term “voice signature” refers to voice characterizing information, characterizing a particular individual's voice. An incoming voice can be compared to this voice characterizing information in order to determine whether or not the incoming voice is the voice of that individual.

Additionally or alternatively, a memory unit is provided which stores, preferably only for the duration of a telephone call or other communication session, a viseme profile corresponding to an incoming call. Typically, the viseme profile may arrive over the data channel of a telephone line, almost simultaneously with the voice data which arrives over the telephone channel. Each viseme typically requires up to 100 msec to arrive, so that a complete profile including 15 visemes may require only 1.5-2 seconds to arrive. Control software (not shown) allows the subscriber to fill the acquaintance viseme reservoir, e.g. by selectably transferring incoming viseme profiles from the short-term memory to the acquaintance reservoir. Typically, the short-term memory is small, capable of storing only a single viseme profile at a time, and the viseme profile for each incoming telephone call overrides the viseme profile for the previous incoming telephone call.

The communication device is also preferably associated with a “self” viseme profile library comprising a memory dedicated to storing one or more viseme profiles which the user has selected to represent himself, and which he/she intends to transmit over the channels of his outgoing calls. The user may choose to download e.g. from a celebrity reservoir such as that of FIG. 6D. Alternatively, the user may elect to provide a viseme profile for himself/herself, e.g. via a viseme-generation website as described in detail below. To generate a viseme profile for himself, a user typically provides a digital image of himself verbalizing a speech input which includes all visemes, or the user scans a video image of himself verbalizing such a speech input.

Generally, payment can be demanded at one or more of the following junctures:

(a) Upon depositing a subscriber's viseme profile in a persona reservoir, payment can be demanded e.g. from the subscriber.

(b) Payment can be demanded e.g. from the retriever upon each retrieval of a persona viseme profile from the persona reservoir.

(c) Payment can be demanded each time a mobile communication device subscriber uses a data channel between mobile communication devices to transmit a persona viseme profile.

A particular advantage of a preferred embodiment of the invention shown and described herein is that a real time “talking” animation is generated using only a speech input, such that no extra bandwidth is required, compared to a conventional speech transaction such as a telephone call. The invention shown and described herein can therefore be implemented on narrow band cell telephones, regular line telephones, and narrow band VoIP (voice over Internet protocol), without requiring any high-speed broad band transmission.

Another particular advantage of a preferred embodiment of the present invention is that speech recognition is performed at the basic, phoneme, level, rather than at the more complex word-level or sentence-level. Nonetheless, comprehension is at the sentence level because the listener is able to use visual cues supplied in accordance with a preferred embodiment of the present invention, in order to resolve ambiguity.

It is appreciated that many other applications of the technology shown and described herein are possible, such as the following example applications:

(a) teenagers' user interface which allows mobile telephone subscribers to build a library of a plurality (typically several dozen) movie star viseme profiles and to assign a movie star viseme profile to each of the friends listed in their contact list. In order to ensure that the assigned viseme profile visually represents the subscriber's speech in the course of a telecon to an individual contact, the assigned viseme profile is transferred over the data channel as telephone contact is initiated between the subscriber and the individual contact. Typically, micropayment for the data transfer is effected via the subscriber's telephone bill.

(b) Like application (a) except that instead of off-line assignment of a viseme profile to each contact, the subscriber is prompted, upon each initiation of a telephone call, to indicate a viseme profile which will visually represent the subscriber's speech to the remote communicant, and/or to indicate a viseme profile which will visually represent the remote communicant's speech to the subscriber.

(c) Homemakers' user interface which allows homemakers to build a library of a plurality of, e.g. several dozen, celebrity viseme profiles and to assign to each home appliance, a celebrity viseme profile to visually represent the appliance's verbal messages during remote communication with home appliances via any suitable communication device such as but not limited to a telephone or palm pilot.

It is appreciated that the present invention allows a home appliance to adopt a persona when delivering an oral message, which persona may or may not be selected by the home-maker. The oral message may or may not be selected by the homemaker and may for example be selected by a sponsor or advertiser.

(d) Retail outlet which, for a fee, videotapes cellular telephone subscribers pronouncing a viseme sequence and transmits the videotape to an Internet site which collects viseme sequences from personas and generates therefrom a viseme profile for each persona for storage and subsequent persona-ID-driven retrieval. Typically, each retrieval of a viseme profile requires the retriever to present a secret code which is originally given exclusively to the owner of the viseme profile. Typically, each retrieval of a viseme profile is billed to the retriever's credit card or telephone bin, using any suitable micropayment technique.

It is appreciated that according to a preferred embodiment of the present invention, no broadband communication capabilities are required because according to a preferred embodiment of the present invention, there is no real time transfer of video signals other than, perhaps, the initial one-time transfer of only a small number of stills representing the viseme profile of the communicant. Even the one-time transfer of the viseme profile need not be in real time.

It is appreciated that the present invention may be useful in conjunction with a wide variety of technologies depending on the application. For example, the following products may be useful in implementing preferred embodiments of the present invention for certain applications:

Trek ThumbDrive USB-connected mobile hard-drive;

CNS 3200 Enhanced Hosted Communications Platform, a software product commercially available from Congruency Inc., or Rochelle Park, N.J. and Petah-Tikva Israel.

It is appreciated that the software components of the present invention may, if desired, be implemented in ROM (read-only memory) form. The software components may, generally, be implemented in hardware, if desired, using conventional techniques.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited to what has been particularly shown and described hereinabove. Rather, the scope of the present invention is defined only by the claims that follow:

1. A system for enhancing an audio reception experience comprising:
a visual output device;
visual content storage supplying visual content to said visual output device;
an audio player operative to play audio content containing non-synthesized voice; and
an audio-visual coordinator operative to cause said visual output device to display said visual content in a manner coordinated with said non-synthesized voice.

2. A system according to claim 1 and wherein said audio-visual coordinator is operative to extract phonemes from said voice and to match said phonemes to visemes in said visual content.

3. A system according to claim 1 and wherein said visual content includes at least one image of at least one person speaking.

4. A system according to claim 3 and wherein said at least one image comprises a plurality of images, each representing at least one viseme.

5. A system according to claim 1 and wherein said visual output device comprises a display screen.

6. A system according to claim 1 and wherein said visual output device comprises a three-dimensional animated object.

7. A system according to claim 6 and wherein said three-dimensional animated object is operative to present a plurality of different visemes.

8. A system according to claim 7 and wherein said three-dimensional animated object is operative to present visemes which are time coordinated with phonemes in said voice.

9. A system according to claim 1 and wherein said visual output device is operative to provide visual cues coordinated with various parameters of said voice.

10. A system according to claim 9 and wherein said various parameters include at least one of intonation, volume, pitch and emphasis.

11. A system for enhancing an audio reception experience comprising:
a three-dimensional animated visual output device;
visual content storage supplying visual content to said visual output device;
an audio player operative to play audio content containing voice; and
an audio-visual coordinator operative to cause said visual output device to display said visual content in a manner coordinated with said voice.

12. A system according to claim 11 and wherein said audio-visual coordinator is operative to extract phonemes from said voice and to match said phonemes to visemes in said visual content.

13. A system according to claim 11 and wherein said visual content includes at least one image of at least one person speaking.

14. A system according to claim 13 and wherein said at least one image comprises a plurality of images, each representing at least one viseme.

15. A system according to claim 11 and wherein said three-dimensional animated object is operative to present a plurality of different visemes.

16. A system according to claim 15 and wherein said three-dimensional animated object is operative to present visemes which are time coordinated with phonemes in said voice.

17. A system according to claim 11 and wherein said visual output device is operative to provide visual cues coordinated with various parameters of said voice.

18. A system according to claim 17 and wherein said various parameters include at least one of intonation, volume, pitch and emphasis.

19. A system for enhancing an audio reception experience comprising:
a visual output device;
visual content storage supplying visual content to said visual output device;
an audio player operative to play audio content containing voice; and
an audio-visual coordinator operative to cause said visual output device to display said visual content in a manner coordinated with said voice, said audio-visual coordinator being operative to extract phonemes from said voice and to match said phonemes to visemes in said visual content.

20. A system according to claim 19 and wherein said visual content includes at least one image of at least one person speaking.

21. A system according to claim 20 and wherein said at least one image comprises a plurality of images, each representing at least one viseme.

22. A system according to claim 19 and wherein said visual output device comprises a display screen.

23. A system according to claim 19 and wherein said visual output device comprises a three-dimensional animated object.

24. A system according to claim 23 and wherein said three-dimensional animated object is operative to present a plurality of different visemes.

25. A system according to claim 24 and wherein said three-dimensional animated object is operative to present visemes which are time coordinated with phonemes in said voice.

26. A system according to claim 19 and wherein said visual output device is operative to provide visual cues coordinated with various parameters of said voice.

27. A system according to claim 26 and wherein said various parameters include at least one of intonation, volume, pitch and emphasis.

28. For use with a visual output device and an audio player operative to play audio content,
an audio reception experience enhancement module comprising:
visual content storage supplying visual content to said visual output device; and
an audio-visual coordinator operative to cause said visual output device to display said visual content in a manner coordinated with said audio content.

29. For use with a three-dimensional animated visual output device and an audio player operative to play audio content,
an audio reception experience enhancement module comprising:
visual content storage supplying visual content to said visual output device; and
an audio-visual coordinator operative to cause said visual output device to display said visual content in a manner coordinated with said audio content.

30. For use with a visual output device and an audio player operative to play audio content,
an audio reception experience enhancement module comprising:
visual content storage supplying visual content to said visual output device; and
an audio-visual coordinator operative to cause said visual output device to display said visual content in a manner coordinated with said audio content, said audio-visual coordinator being operative to extract phonemes from said audio content and to match said phonemes to visemes in said visual content.

31. Apparatus for generating a visual representation of speech comprising:
a reservoir of viseme profiles storing at least one viseme profile, each viseme profile including a complete set of visemes respectively depicting different speech production positions of a persona, each viseme profile being linked to information identifying its persona;
a phoneme extractor operative to receive a speech input and to derive therefrom a timed sequence of phonemes included therewithin; and
a visual speech representation generator operative to access a viseme profile from said reservoir and to present a visual representation to accompany said speech input, the visual representation including a viseme sequence formed from visemes included in the viseme profile which respectively match the phonemes in said timed sequence, wherein the visual representation generator presents each viseme generally simultaneously with its matching phoneme.

32. Apparatus according to claim 31 and also comprising a user interface operative to prompt a user to define at least one characteristic of at least one telephone communication session and to select at least one viseme profile within said reservoir to be associated with said telephone communicant.

33. Apparatus according to claim 32 and wherein said visual speech representation generator is operative to present a visual representation formed from the viseme profile selected by the user, to accompany a speech input generated in the course of said telephone communication session.

34. Apparatus according to claim 31 wherein said visual speech representation generator comprises apparatus for generating a visual speech representation which is integrally formed with a household appliance.

35. Apparatus according to claim 31 wherein said reservoir of viseme profiles comprises a user interface operative to prompt a user to provide a viseme profile access request including confirmable information identifying a persona whose viseme profile the user wishes to access, and also operative to provide the persona's viseme profile to the user.

36. Apparatus according to claim 35 wherein the user interface and the user communicate via a computer network.

37. Apparatus according to claim 35 wherein said user interface is also operative to impose a charge for providing the persona's viseme profile to the user including obtaining the user's approval therefor before providing the persona's viseme profile to the user.

38. Apparatus according to claim 31 wherein said visual speech representation generator comprises apparatus for generating a visual speech representation which is integrally formed with a goods vending device.

39. Apparatus according to claim 38 wherein said goods vending device comprises a beverage dispensing machine.

40. Apparatus according to claim 31 wherein said visual speech representation generator comprises apparatus for generating a visual speech representation which is integrally formed with a services dispensing device.

41. Apparatus according to claim 40 wherein said services dispensing device comprises an automatic bank teller.

42. Apparatus according to claim 31 wherein said visual speech representation generator is operative to present the visual representation on a display screen of a communication device.

43. Apparatus according to claim 42 wherein the communication device comprises an individual one of the following group of communication devices having display screens: personal digital assistant, cellular telephone such as a third generation cellular telephone, wired telephone, radio, interactive television, beeper device, computer such as a personal computer, portable computer or household computer, television, screenphone, electronic game, and devices having a plurality of physical positions which can be correspond to speech production positions.

44. Apparatus according to claim 31 wherein said reservoir, phoneme extractor and visual speech representation generator are all cached in a telephone.

45. A method for generating a visual representation of speech comprising:
providing a reservoir of viseme profiles storing at least one viseme profile, each viseme profile including a complete set of visemes respectively depicting different speech production positions of a persona, each viseme profile being linked to information identifying its persona;
receiving a speech input and deriving therefrom a timed sequence of phonemes included therewithin; and
accessing a viseme profile from said reservoir and presenting a visual representation to accompany said speech input, the visual representation including a viseme sequence formed from visemes included in the viseme profile which respectively match the phonemes in said timed sequence, wherein each viseme is presented generally simultaneously with its matching phoneme.

46. A method according to claim 45 wherein said stop of providing a reservoir comprises, for each of a plurality of personas:
generating a sequence of visual images representing the persona uttering a speech specimen including all visemes in a particular language; and
identifying from within the sequence of visual images, and storing, a complete set of visemes.

47. A method according to claim 45 wherein said step of providing comprises storing at least one viseme profile in a first communication device serving a first communicant and, upon initiation of a communication session between the first communicant and a second communicant, transmitting the viseme profile between the first communication device and a second communication device serving the second communicant,
and wherein said step of accessing and presenting comprises presenting, on a screen display associated with the second communication device, a viseme sequence formed from visemes included in the viseme profile transmitted from the first communicant to the second communicant.

48. A method according to claim 47 wherein said step of transmitting comprises sending the viseme profile in near real time via a data channel while a telephone call is in progress.

49. A method according to claim 47 wherein said step of sending employs a multimedia messaging service.

50. Apparatus for generating a visual representation of speech comprising:
a toy having several speech production positions;
a speech production position memory associating each phoneme in a language with an individual one of the speech production positions;
a phoneme extractor operative to receive a speech input, to derive therefrom a timed sequence of phonemes included therewithin, and to derive therefrom, using said speech production position memory, a correspondingly timed sequence of speech production positions respectively corresponding to the phonemes in said timed sequence; and
a toy speech position controller operative to actuate the toy to adopt said correspondingly timed sequence of speech production positions.

51. A business card comprising:
a card presenting contact information regarding a bearer of the card including information facilitating access to a viseme profile of the bearer.

52. Stationery apparatus comprising:
stationery paper including a header presenting contact information for at least one individual including information facilitating access to a viseme profile of at least one individual.

53. A website comprising:
a web page presenting contact information for at least one individual associated with the website including information facilitating access to a viseme profile of the individual.
